(19) United States
(12) Patent Application Publication
(10) Pub. No.: US 2007/0078780 A1
(43) Pub. Date: Apr. 5, 2007

(54) Bio-conversion system for banking and merchant markets

(76) Inventors: Van Thuy Tran, Golden Valley, MN (US); John R. Kingsley-Hefty, Edina, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/521,188

(22) Filed: Sep. 14, 2006

Related U.S. Application Data
(60) Provisional application No. 60/717,667, filed on Sep. 16, 2005.

(51) Int. Cl. G06Q 99/00

(52) U.S. Cl. 705/65

(57) ABSTRACT

A high-security Transaction Card includes a card body having a perimeter and at least one face with a magnetic strip on at least one face or, electronic storage device such as used in a smart card having non-biometric data encoded therein. At least one two-dimensional Symbol encoded with binary data is included. The Symbol is located within the perimeter of the Transaction Card body on at least one face and the Symbol may have an identifying representation of biometric data of the authorized Transaction Cardholder encoded therein.

### REFERENCE TO RELATED APPLICATIONS

This application claims priority to U.S. Provisional Application having Ser. No. 60/717,667, filed Sep. 16, 2005, entitled “BIO-CONVERSION SYSTEM FOR BANKING AND MERCHANT MARKETS,” which application is incorporated herein by reference in its entirety for all purposes.

### BACKGROUND

The invention generally relates to a high security/low cost bio-verification transaction-type card and system utilizing what is commonly known as a two-dimensional bar code symbology, preferably incorporating a high density code capable of encoding biometric data, such as the VeriCode® or VSCode® technology, as such two-dimensional bar code technology is commercially available from Veritec, Inc. of Golden Valley, Minn. (hereinafter, “Veritec”); and/or, the VeriCode® Symbol as more particularly described in U.S. Pat. No. 4,924,078 (Sant' Anselmo et al.) (hereinafter, references to “Symbol” may include this technology as well as like technologies); to be read, scanned or other wise decoded by the means taught by the '078 patent, together with U.S. Pat. Nos. 5,331,176 and 5,612,524 (Sant' Anselmo et al.) (Without an intent to make the claims of this application dependent upon them, the art and practice taught by the foregoing '078, '176 and '524 patents are incorporated herein by this reference as if set forth in full); or, by way of a fixed and stationary scanner or camera capturing the image of the Symbol for verification by software embedded therein or, loaded or installed in a computer, server or other data processing device.

Credit cards, including debit cards, check cashing cards, other financial transaction cards and identification cards, are well known and have been successfully utilized for conducting business transactions, security and identification verification of individuals for many years. Such credit cards, debit cards, check cashing cards, financial transaction cards and identification cards, among others (hereinafter, “Transaction Cards”) are typically constructed from a durable material having a rectangular shape. Transaction Cards usually contain specific information that relates to identification or financial information of the authorized user. Such information may be embossed on the Transaction Card as raised alphanumeric characters or, contained in a magnetic strip or electronic storage device attached to or embedded within the Transaction Card. Information may consist of alphanumeric characters corresponding to the individual's account number, identifying PIN number, the Transaction Card's expiration date and other limited amounts of personal data. Moreover, some Transaction Cards may include a picture of the authorized cardholder printed on the face or obverse thereof. Each type of Transaction Card typically is intended to communicate unique data for a particular financial institution, retail loyalty program or the like, as well as, of the authorized Transaction Cardholder.

Modernly, countless numbers of individuals use Transaction Cards in payment transactions for the purchase of goods and services of every nature and kind at physical locations; by providing the information found on Transaction Card over the telephone; and, over the Internet. In use, an individual provides a Transaction Card for payment by providing it to a sales person or clerk; or, by swiping the Transaction Card through a reader or electronic point of sale reading and communication device. In some instances the individual must provide a PIN Number to consummate the transaction. If a Transaction Card not containing the features of the present invention is lost or stolen, it is possible for a wrongdoer to utilize it for cash advances and purchases prior to the time it is reported lost or stolen by the authorized user and cancelled. A sales person or clerk may ask for alternative forms of identification that may also be in the wrongdoer's possession or, may ask for a signature comparison to the signature appearing on the Transaction Card and easily copied by the wrongdoer or, the sales person or clerk processing the transaction may do nothing at all to verify that the individual attempting to utilize the Transaction Card is the person authorized to do so. The verification methods currently being utilized in whole or in part are flawed. Whether employed singularly or in combination existing practices do not provide the level of security the Inventors believe is required for financial transactions and have been proven by history to be ripe for potential fraud and consumer misuse resulting in incalculable losses to the retail and banking industries, as well as, to Transaction Cardholders whose identity and/or confidential Transaction Card information has been misappropriated. Also, it may be possible for a wrongdoer to access cash at an “ATM” machine or other automated transaction device solely by virtue of the fact that the wrongdoer has physical possession of the Transaction Card and discovered the authorized user's PIN Number. With the increase of fraud and identity theft, providers of goods and services, financial institutions and individuals are paying directly and indirectly for the losses incurred by such theft and thereby have a growing desire and need in privacy and security for the means by which they provide financial informational and utilize Transaction Cards. Accordingly, there is a need to minimize possible use by unauthorized individuals by increasing the security for these types of Transaction Cards. This invention provides a unique and novel means to solve the problems of security and verification of an authorized user for transactions conducted by way of Transaction Cards.

The techniques and novel uses described hereinbelow, extends to those embodiments that fall within the scope of the appended claims; as well as, any such other embodiments utilizing a Symbol or other image on Transaction Cards regardless of use.

### SUMMARY

What is provided is a high-security Transaction Card. The high-security Transaction Card includes a card body having a perimeter and at least one face. The high-security Transaction Card also includes at least one magnetic strip or other electronically readable device on the face or obverse thereof or, embedded therein. Further, the high-security Transaction Card includes at least one two-dimensional binary information Symbol. The Symbol is located within the perimeter of the card body on at least either the face or obverse thereof; and, the Symbol is an embodiment that represents or stores the biometric data of an authorized Transaction Cardholder encoded therein.

What is also provided is a method of Transaction Card enrollment. The method comprises receiving biometric data from a user and associating the biometric data with other authorized user and Transaction Card issuer definable data. The method also includes producing a Transaction Card having a two-dimensional binary information Symbol applied to the Transaction Card and having coded therein the biometric and other authorized user and issuer definable data. The Transaction Card also has a representation of at least some of the user data coupled thereto.

Further, what is provided is a method of transaction using a Transaction Card to which has been applied a Symbol properly encoded. The method includes providing a Transaction Card having a two-dimensional binary information Symbol containing or representing the unique biometric information about a user encoded therein together with images of the user and such other user and issuer definable data. The method also comprises reading the data information from the Transaction Card. The method further includes the means for an authorized user's providing a comparison biometric information at the time and at the “point of sale” or other use of the Transaction Card. Further still, the method includes comparing of the original encoded biometric information encoded on the Transaction Card with that given by the user at the time and at the “point of sale” for comparison; and, authorizing or denying the transaction based on the comparison.

Further still, what is provided is a bio-conversion package. The package includes a processor and a Transaction Card reader configured to read a two-dimensional binary information Symbol on a Transaction Card having a representation of biometric information encoded therein and the Transaction Card reader configured to read other user information encoded on the Transaction Card. The package also includes a biometric sensor coupled to the processor and configured to receive biometric information from a user.

Alternative exemplary embodiments relate to other features and combinations of features as may be generally recited in the claims.

### BRIEF DESCRIPTION OF THE DRAWINGS

A better understanding of the features and advantages of the present invention will be obtained by reference to the following detailed description that sets forth illustrative embodiments by way of example only, in which the principles of the invention are utilized, and the accompanying drawings, of which:

FIG. 1 is an exemplary diagram of a Transaction Card having a magnetic strip and a two-dimensional binary information Symbol;

FIG. 2 is an exemplary diagram of a Transaction Card enrollment and order system;

FIG. 3 is an exemplary diagram of a bio-card verification system;

FIG. 4 is an exemplary diagram of a bio-conversion package;

FIG. 5 is an exemplary diagram of a Transaction Card enrollment process; and,

FIG. 6 is an exemplary diagram of a Transaction Card transaction and verification process.

### DETAILED DESCRIPTION

Before describing in detail the particular improved system and method, it should be observed that the invention includes, but is not limited to a novel structural combination of conventional data/signal processing components and communications circuits, and not in the particular detailed configurations thereof. Accordingly, the structure, methods, functions, control and arrangement of conventional components and circuits have, for the most part, been illustrated in the drawings by readily understandable block representations and schematic diagrams, in order not to obscure the disclosure with structural details which will be readily apparent to those skilled in the art, having the benefit of the description herein. Further, the invention is not limited to the particular embodiments depicted in the exemplary diagrams, but should be construed in accordance with the language in the claims.

U.S. application Ser. No. 11/253,064, filed Oct. 18, 2004, entitled “SECURE CARDS AND METHODS,” is incorporated herein by reference in its entirety. Also, U.S. application Ser. No. 10/713,247, filed Nov. 13, 2003, entitled “BIO-CONVERSION SYSTEM FOR BANKING AND MERCHANT MARKETS,” is incorporated herein by reference in its entirety. Both of these references may provide support for the disclosure as provided herein.

In accordance with an exemplary embodiment, a verification mechanism is incorporated into Transaction Cards and the systems that process such commercial transactions by introducing a high security Symbol onto Transaction Cards (or the like), to reduce and/or eliminate fraud.

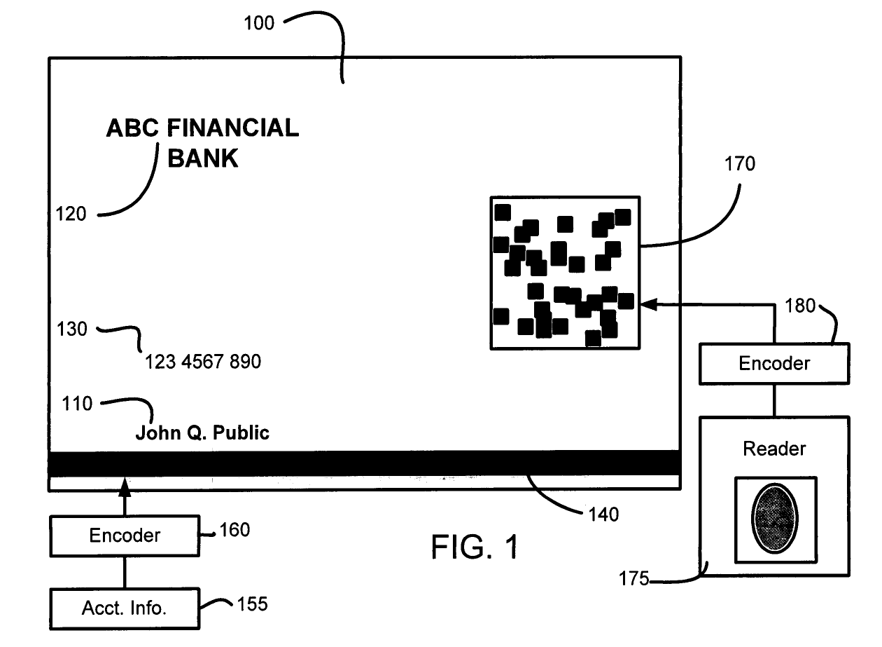

Referring now to FIG. 1, a Transaction Card or other card 100 is depicted. Transaction Card 100 may include a user's name 110, a financial institution name 120, and an account number 130. Such Transaction Cards may be made of any of a variety of plastics which can be printed on or accept labeling. In accordance with an exemplary embodiment, a magnetic strip 140 has account information and/or other information encoded therein. In one exemplary embodiment, magnetic strip 140 may be adhered or printed on the opposing side of Transaction Card 100. In accordance with an exemplary embodiment, account information 150 is passed through an encoding 160 before being transferred to magnetic strip 140. Also, in accordance with an exemplary embodiment, biometric data may be encoded in a two-dimensional binary information Symbol 170. A biometric data sensor, such as but not limited to a fingerprint reader 175 may be used to sense a user fingerprint. Alternatively other types of biometric sensors may be used such as an eye pattern sensor, a signature pad, a digital camera, a voice sensor, etc. Fingerprint sensor 175 may be coupled to an encoder 180 to encode a fingerprint or other biometric data source into data to produce information Symbol 170.

A system in accordance with an exemplary embodiment may include at least the following two functions:
I. Transaction Card Holder Enrollment where the individual user's information may be entered into the software and/or data record for enrollment processing, resulting in a permanent Transaction Card being printed with the Symbol and issued to the Transaction Cardholder; and,
II. The Transaction Card Reading/Verification of the Symbol as an activated data storage or retrieval means for the Transaction Card.

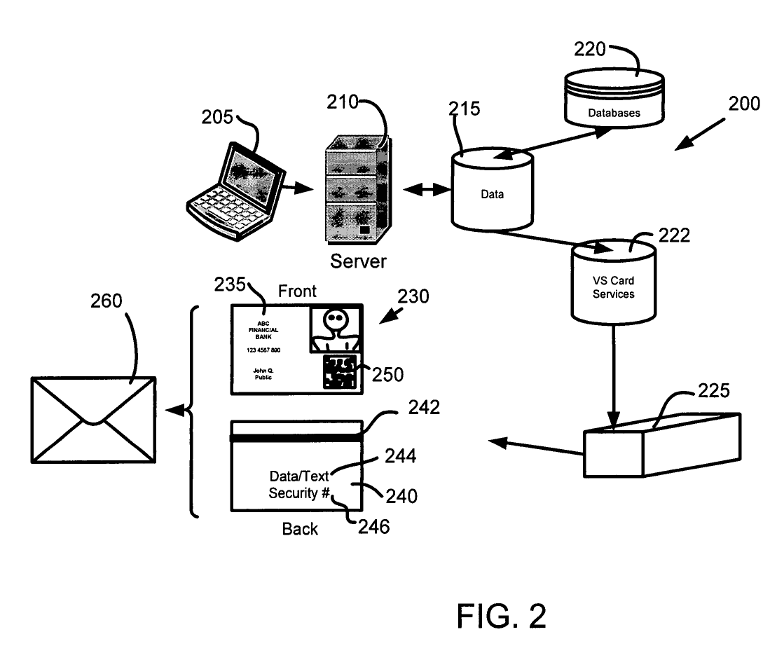

In the Transaction Card Enrollment process, elements of a preferable system/process may include any computer processing or microprocessor-based system, such as a standard PC with windows-based operating system as such can provide an “enrollment station” that is linked to the bank's Transaction Card services bureau. Referring to FIG. 2, a system 200 is depicted having a bank PC 205 coupled to a bank server 210. Bank PC 205 preferably may include:
a. PC that may be provided by a bank or merchant;
b. The applicable software for coding data (such as but not limited to biometric data) and writing or saving the data as a two-dimensional Symbol or the like;
c. A fingerprint reader used to capture an individual user's biometric finger template;
d. A digital camera kit to capture an individual user's photo in a digital format, such as in jpeg image format (or alternatively other digital image formats); and
e. Optionally, a signature pad to capture the individual's signature graphic in a digital form or anyway as an image capture.

Bank server 210 receives information from Bank PC 205 to develop, create or generate the Symbol or other two-dimensional binary code. All of the information is communicated to bank server or bank central database 215 which enables a query to other databases 220, such as government databases, local databases, governmental agency databases, etc. in order to provide validity of the information entered to bank central database 215. In accordance with an exemplary embodiment, the fingerprint or other biometric data may be checked with a government database such as an FBI or Police database to check for prior criminal records or other legal issues. Once verified, the bank server 210 confirms an authorization to assign an account to a user. The bank server 210 then provides a request to bank central database 215 to request the issuance of a customer Transaction Card. Bank central database 215 requests the customer Transaction Card from a Transaction Card service system. A Transaction Card is produced with a Transaction Card production facility 225. In accordance with an exemplary embodiment, a Transaction Card 230 is produced having a front side 235 and a backside 240. Front side 235 may include but is not limited to bank user 236, customer name 237, account number 238, customer photo 239, and two-dimensional binary information Symbol 250. Backside 240 may include a magnetic strip 242, data/text for information purposes 244, and a security number 246 (such as but not limited to a CID number). Once the Transaction Card is produced, it may then be mailed 260 to the customer.

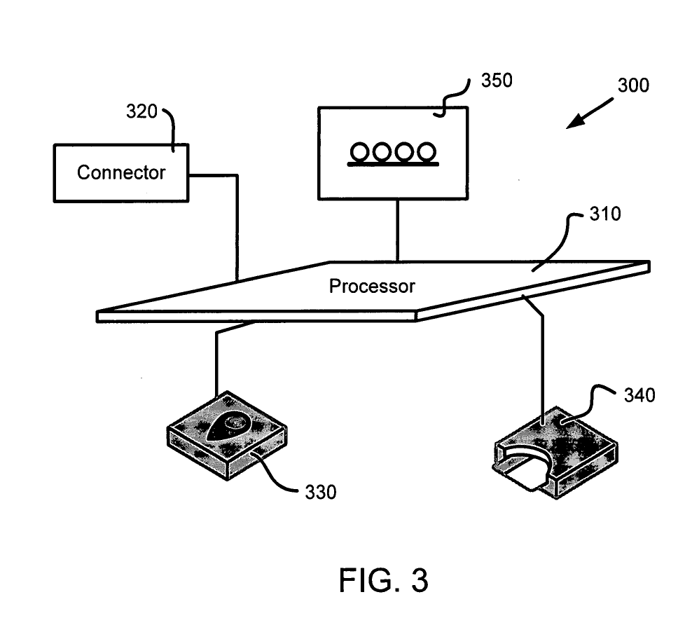

A Transaction Card Reader/Verification element of a preferred system/process may comprise, a station or package 300 (FIG. 3) which may preferably include:
a. A small processor 310 (such as mini-motherboard) with a compatible operating system to house and run the software and supporting device drivers (larger processors and PCs may also be used in package 300);
b. A data cable connector 320 to intercept and pass the Transaction Cards magnetic strip data as obtained from a magnetic strip reader (as such as conventionally known);
c. The software as such software is able to read and decode a two-dimensional bar code (the dimensional binary information Symbol);
d. A fingerprint reader 330 to read the individual user's “live” biometric finger template and to convert the biometric data to digital information;
e. A Transaction Card scanner or a reader such as but not limited to a Veritec CR-100 340 that can read the Symbol and provide such digital information to the software for decoding to permit a digital comparison of the printed finger template against the “live” finger template of the person attempting use the Transaction Card for a purchase of goods and services; and
f. Processing LED/lights 350 to communicate results of the Transaction Card verification process and status.

These two integrated elements complete the basic functionality that is desirable to make a “bio-conversion” package that can be utilized in commercial transactions and in the banking industry. One important advantage of one exemplary embodiment is that as a “standalone” conversion package, bankers and merchants are in a position to upgrade their current systems without replacing existing equipment, either from the ATM machine level or down to the individual point of sale machines/registers. The enrollment element allows the Transaction Card issuer to electronically submit authorized Transaction Cardholder information directly to a bank for first verification and then account registration, followed by Transaction Card production/issue, such as through any high security card printing service having the ability to print a two-dimensional bar code Symbols along with the other information and graphics and the like. Such ability is provided by systems commercially available for example from Veritec Inc. of Golden Valley, Minn.

This exemplary approach acknowledges that the magnetic strip or smart card technology using such technologies as RFID may continue to be the base technology in the card market for some time. An exemplary embodiment of the invention is based on the ability to function along with this technologies. The current magnetic strip or electronic device readers read the data stored within the magnetic tracks on the Transaction Card or stored in the electronic device. The readers, in turn, typically transmit the Transaction Card data in a standard ISO protocol upstream in the processing engine of the ATM or POS device.

With a bio-conversion package, such as package 300, in accordance with the invention, the system would preferably intercept that standard ISO magnetic strip data protocol communications stream (from the reader) and hold that data, temporarily, while the system processes the Symbol (or embodiment) along with the Transaction Cardholder's live finger template for a biometric match/verification. If the match of the live biometric information and stored information from the Symbol is positive, the data of the magnetic strip would then be released to allow the data to continue on to the ATM or POS processor to complete the normal transaction. A package in accordance with an exemplary embodiment of the invention may thus perform a high security “gate keeper” function.

If the reading of the Symbol and comparison is negative, the merchant would deny acceptance of the Transaction Card as a means of payment.

In accordance with one or more exemplary embodiments, the advantages of this system may include that the banker has the opportunity to introduce high security, at low cost into their card services and reduce and/or eliminate losses in Transaction Card fraud on three levels:

a. Losses to the bank;

b. Losses to the merchants; and/or

c. Personal losses to the Transaction Card holder.

The application also incorporates by reference the entire subject matter of U.S. Provisional Application Ser. No. 60/620,397 filed Oct. 19, 2004 naming Johanns and vonKlinggraeff as inventors.

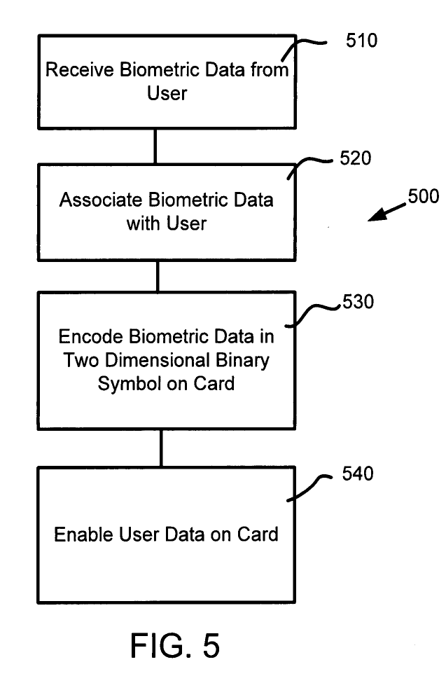

Generally, as exemplified schematically in FIG. 2 and shown as a process diagram in FIG. 5, a process of making a secure Transaction Card in accordance with one or more exemplary embodiments of the invention is shown and preferably includes steps of obtaining data from a data source, encoding the data, generating a digital data matrix from the encoded data, and storing the data. However, additional steps are contemplated such as data processing steps for manipulating, converting, editing, or otherwise acting on or processing the data in any desired way.

An initial step of a process 500 depicted in FIG. 5 preferably comprises receiving biometric data from a data source such as from a biometric sensor or the like (process 510). The data may further comprise any data that is desired to be provided in a secure and encrypted form. Such data may comprise personal or biometric data such as fingerprint data and possibly other data including but not limited to, account based information, such as access numbers, account numbers, addresses or the like, or any other information, for example. Such data may be provided in any form such as an alphanumeric, graphical, or image-based form. Personal data may include personal information such as a person's name, address, account numbers, bank codes and the like. Biometric data may be a finger print identification, face feature identification, eye feature identification, face image, electronic signature identification or other means to specifically identify an individual person. In any case, the data preferably comprises storable data that is desired to be stored in a secure encrypted form and printed or otherwise provided onto a Transaction Card in a secure manner. The data stored in the encrypted form is associated with a particular person or user (process 520).

After the data is identified, an encoding step is preferably used to encode the data (process 530). Such encoding is used to put the data into digital form and may include steps of storing data in memory, entering data by keying with a keyboard or the like, reading data from a magnetic strip or electronic device of a Transaction Card, creating images or pictures, as well a scanning a thumbprint or eye scan or other biometric based data. Preferably a software coding process is used and such software coding of data can be done by any desired technique. For example, data to be encoded can be compressed and encrypted using known methods and then converted to a binary stream of ones and zeros. The binary information can then be further encrypted to allow Error Detection And Correction (EDAC). Reed-Solomon error correction, now used by almost all 2D bar codes, is a byte-correcting scheme that is widely used for digital storage applications in fields such as telecommunications, for example. By this technique, Reed-Solomon error correcting code words are incorporated along with data code words to form an integrated message. Area symbologies as well as techniques for electronically coding data are well known, such as are described in U.S. Pat. No. 5,612,524, U.S. Pat. No. 5,331,176, U.S. Pat. No. 4,972,475, and U.S. Pat. No. 4,924,078, the entire disclosures of which are incorporated herein by reference for all purposes. Other techniques for encoding and decoding information are also disclosed in Applicant's copending U.S. Provisional Patent Application No. 60/567,761, entitled “Methods for Encoding and Decoding Information,” filed on May 3, 2004, the entire disclosure of which is incorporated herein by reference for all purposes. Also, secure Transaction Cards using two-dimensional marks and method of making and using such cards are disclosed in Applicant's copending U.S. patent application Ser. No. 10/713,247, entitled “High-Security Card and System,” filed on Nov. 13, 2003, the entire disclosure of which is incorporated herein by reference for all purposes.

A digital data matrix, in the form of a Symbol or mark, is then generated as the embodiment of the encoded data. The digital data matrix may be applied by printing directly to the Transaction Card; or, by printing to a label to be later affixed to the Transaction Card. The label would contain specific security features such as color shifting ink; or, holograms and peel prevention protection and the like that can be utilized alone or in combination. For example, the encrypted binary stream is distributed to a 2-dimensional symbology such as a matrix array. An area symbology as used herein, refers to a Symbology, such as those commercially known under the trade names VeriCode® or VSCode® as taught by the 078, 176 and 524 Patents, that employs a matrix of data cells. As an example, the encoded data can be used to create the matrix of cells. This can be done by digitizing the encoded data into binary bit form and processing by a software algorithm to generate a code. Such techniques are known in the art such as described in the above-identified U.S. patents.

Preferably, a digital data matrix (such as a VeriCode® or VSCode® matrix, for example) is then stored on a printed Transaction Card. Preferably, the digital data matrix is provided in a form that can be printed on a typical Transaction Card that can be carried in a purse or wallet or the like. In order to do so, however, it may be desirable to reduce the size or compress the data matrix. This can be done by managing the cell sizes and dots per cell used during the printing process thereby allowing the Symbol to be decoded through the use of a predetermined reader.

In the exemplary process shown, other user data, such as but not limited to, account information may be encoded on the user Transaction Card on a magnetic strip or the like (process 540).

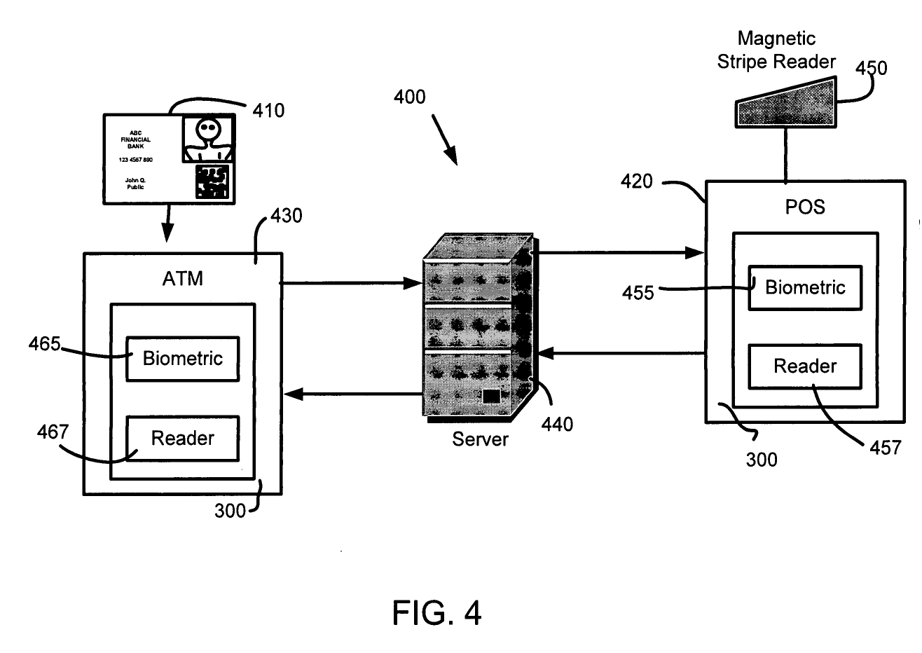

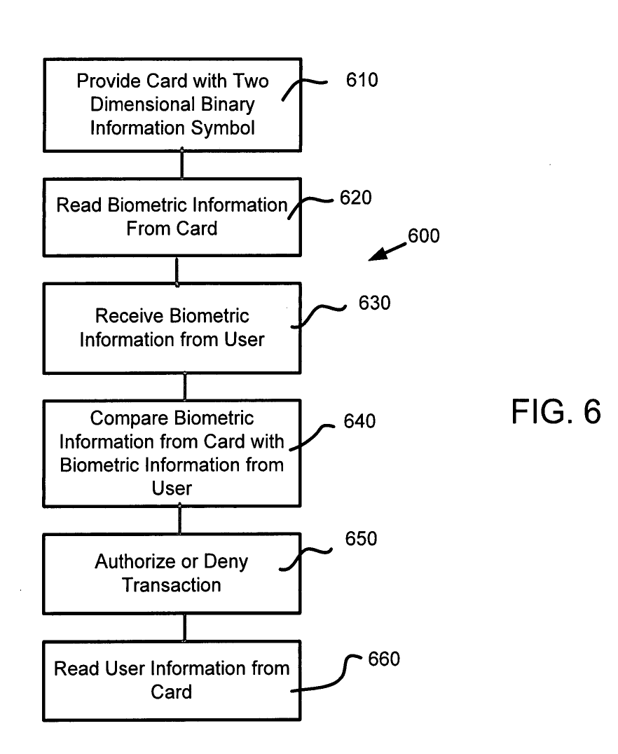

Referring now to system 400 of FIG. 4, a secure Transaction Card 410 having a printed 2-dimensional matrix as a coded mark can be used by a Transaction Cardholder to proceed with a transaction at a point of sale (POS) 420 or an automated teller machine (ATM) 430 as schematically illustrated in FIG. 4 and as a process 600 as depicted in FIG. 6. Both POS 420 and ATM 430 may be coupled to a server 440 which handles banking or financial transactions. In a POS 420 transaction a customer service personnel may swipe Transaction Card 410 in a magnetic strip reader 450 that is part of POS 420. POS 420 also includes a biometric sensor 455 configured to receive biometric input from the Transaction Cardholder. Such biometric input may be in the form of a fingerprint application to a fingerprint reader, or the like. POS 420 may also include a Transaction Card reader which is configured to read a Symbol, such as a two-dimensional binary code Symbol, which has a Transaction Cardholder biometric data encoded therein. The biometric sensor, and Transaction Card reader may be a part of package 300 as depicted in FIG. 3. Similarly, ATM 430 includes a package 300 which includes a Transaction Card reader 467 and a biometric sensor 465 while retaining a conventional magnetic stripe reader as is known the art.

A process 600 of FIG. 6 includes the following steps: first a secure Transaction Card with a 2-dimensional matrix is placed in a reader (process 610) in order to have the 2-dimensional matrix read and decoded (process 620). If finger print authentication is encoded into the 2-dimensional matrix, the Transaction Cardholder then places their finger onto an accompanying fingerprint reader (process 630). The reader generates a set of minutia points and through the use of decoding software compares them to those encoded in the 2-dimensional matrix (process 640). Once the comparison has been made and a positive validation has been obtained, the transaction may be authorized (process 630) or if the validation were negative, denied. User information may also be read from the Transaction Card such as account information which may be encoded on a magnetic stripe as is conventionally known (process 660).

It is contemplated that any type of authentication may be used. A photographic image of one or more authorized Transaction Cardholders may be included in the two-dimensional matrix. A store clerk can access the images and can use such images to make a positive identification of an authorized user. Once a clerk verifies a Transaction Cardholder's identity, the clerk can authorize access to the payment method provided by the secure Transaction Card. In this way, multiple individuals may be authorized to use the same secure Transaction Card such as spouses who have joint access to a particular financial account. Other information may be used for authenticating an authorized user such as information related to a physical description of the user. Moreover, the encoded Symbol could contain information to limit they types of transactions of specific users to specific types of transactions and/or limit them to specific sums of money. This feature is extremely novel and would be useful to control spending habits and cash advances when children would be an authorized user of their parents Transaction Card.

In one exemplary embodiment, a high-security Transaction Card includes a Transaction Card body 100 having a perimeter and at least one face. At least one magnetic strip or electronic storage device such as used in a smart card, 140 on at least one face, has non-biometric data encoded therein. At least one two-dimensional binary information Symbol 170. The Symbol is located within the perimeter of the Transaction Card body 100 on at least one face and the Symbol has an identifying representation of biometric data of the authorized Transaction Cardholder encoded therein. The Transaction Card may be a high-security Transaction Card or a high-security identification card. The two-dimensional Symbol 170 is used to store, or represent unique biometric data including fingerprint data, retinal or choroid data, voice recognition data. The non-biometric data may include account information or other Transaction Cardholder or user information.

In accordance with a particular exemplary embodiment, a bio-conversion package 300 of FIG. 3 or a similar bio-conversion package may include a processor 310. The package also includes a Transaction Card reader 340 that is configured to read a two-dimensional binary information Symbol on the Transaction Card having a representation of biometric information encoded therein. The Transaction Card reader is also configured to read other user information encoded on the Transaction Card. The bio-conversion package further includes a biometric sensor 330 coupled to processor 310 and configured to receive biometric information from a user. The package may be incorporated into a point of sale terminal or into an automated teller machine or other transaction device.

While the detailed drawings, specific examples, and particular formulations given described exemplary embodiments, they serve the purpose of illustration only. It should be understood that various alternatives to the embodiments of the invention described maybe employed in practicing the invention. It is intended that the following claims define the scope of the invention and that structures within the scope of these claims and their equivalents be covered thereby. The hardware and software configurations shown and described may differ depending on the chosen performance characteristics and physical characteristics of the computing and analysis devices. For example, the type of computing device, communications bus, or processor used may differ. The systems shown and described are not limited to the precise details and conditions disclosed. Method steps provided may not be limited to the order in which they are listed but may be ordered any way as to carry out the inventive process without departing from the scope of the invention. Furthermore, other substitutions, modifications, changes and omissions may be made in the design, operating conditions and arrangements of the exemplary embodiments without departing from the scope of the invention as expressed in the appended claims.

What is claimed is:

1. A high-security Transaction Card, comprising:
a Transaction Card body having a perimeter and at least one face;
at least one magnetic strip or electronic data storage device coupled to the body, having non-biometric data encoded therein; and,
at least one two-dimensional binary information Symbol, the Symbol being located within the perimeter of the Transaction Card body on at least one face and the Symbol having an identifying representation of biometric data of the authorized Transaction Cardholder encoded therein.

2. The high-security Transaction Card of claim 1, wherein the card is a high-security Transaction Card.

3. The high-security Transaction Card of claim 1, wherein the card is a high-security identification card.

4. The high-security Transaction Card of claim 1, wherein the Symbol comprises the elements of digitized data.

5. The high-security Transaction Card of claim 1, wherein the biometric data comprises fingerprint data.

6. The high-security Transaction Card of claim 1, wherein the biometric data comprises retinal or choroids data.

7. The high-security Transaction Card of claim 1, wherein the biometric data comprises voice recognition data.

8. The high-security Transaction Card of claim 1, wherein the non-biometric data comprises account information.

9. A method of Transaction Card enrollment, comprising:
receiving biometric data from a user;
associating the biometric data with user data; and
producing a Transaction Card having a two-dimensional binary information Symbol applied to the Transaction Card and having coded therein the biometric data, the Transaction Card also having a representation of at least some of the user data coupled thereto.

10. The method of claim 9, further comprising:
entering user data via a computer.

11. The method of claim 9, further comprising:
sensing biometric data from a user.

12. The method of claim 9, further comprising:
determining validity of biometric and user data.

13. The method of claim 9, further comprising:
authorizing production of a Transaction Card.

14. The method of claim 9, further comprising:
sending completed Transaction Card to user.

15. A method of transaction using a Transaction Card, comprising:
providing a Transaction Card having a two-dimensional binary information Symbol having first biometric information about a user encoded therein so that the Transaction Card has a representation of the authorized user's information;
reading the user information from the Transaction Card;
reading the first biometric information from the Transaction Card;
receiving second biometric information from the user;
comparing first and second biometric information; and,
authorizing or denying the transaction based on the comparison.

16. The method of claim 15, further comprising:
completing the transaction.

17. The method of claim 15, wherein the transaction is a point of sale transaction.

18. The method of claim 15, wherein the transaction is an automated teller machine transaction.

19. A bio-conversion package, comprising:
a processor;
a Transaction Card reader configured to read a two-dimensional binary information Symbol on the Transaction Card having a representation of biometric information encoded therein and the Transaction Card reader configured to read other user information encoded on the Transaction Card; and
a biometric sensor coupled to the processor and configured to receive biometric information from a user.

20. The bio-conversion package of claim 19, wherein the package is incorporated into a point of sale terminal.

21. The bio-conversion package of claim 19, wherein the package is incorporated into an automated teller machine.
